(19) United States
(12) Patent Application Publication
(10) Pub. No.: US 2018/0327693 A1
(43) Pub. Date: Nov. 15, 2018

(54) Liquid Detergent Composition and Use of it

(71) Applicant: Reckitt Benckiser Vanish B.V., Hoofddorp (NL)

(72) Inventors: Anna CRESTANA, Mira (IT); Remigio MUSCI, Mira (IT)

(21) Appl. No.: 15/775,624

(22) PCT Filed: Oct. 5, 2016
(86) PCT No.: PCT/GB2016/053098

§ 371 Date: May 11, 2018

(30) Foreign Application Priority Data
Nov. 16, 2015 (GB) 1520128.8

(51) Int. Cl. C11D 3/30; C11D 1/22; C11D 11/00

(52) U.S. Cl. CPC C11D 3/30; C11D 11/0017; C11D 1/22

(57) ABSTRACT

A liquid detergent composition having a thickening system comprises triethanolamine.

This invention relates to aqueous liquid detergents, preferably for use as a laundry composition or in conjunction with a laundry detergent.

Liquid based laundry compositions have been known for many years. A major issue encountered with such compositions has been the achievement of a suitable viscosity for the liquid: the liquid has to be viscous enough so that any particles are suspended yet have a sufficiently high degree of flow for ease of manufacture and dispense by a consumer. To achieve the desired rheology typically thickeners are used. These thickeners are rheology modifiers suitable for liquid detergents. They are used to associate a higher concentration of active ingredients and to aggregate them in a stable matrix.

Numerous thickening systems have been developed over the years but there is still room for improvement in such systems, particularly as regards cost effectiveness and environmental concerns.

Different kinds of thickener are commercially available. One class of thickener that is used extensively are those based upon polymeric-carboxylic acids and their salts.

Whilst generally these thickeners are highly effective one significant disadvantage in their use is that their efficacy is highly dependent on the pH and ionic strength of the liquid in which they are employed. Indeed the thickening effect of carboxylic acid based thickeners is only significant in alkaline solutions and/or solution having low ionic strength when the carboxylic acid based thickeners are in a dissociate state.

In such a condition the thickening mechanism is based on 2 main effects:

In an alkaline environment the carboxylic acid dissociates to carboxylate anions. As a result the electrostatic repulsion of the anions causes the stretching of the polymer chain. This phenomenon reduces the degrees of freedom of the structure in the liquid matrix. Moreover the carboxylate anions interact with the hydrophilic heads of the surfactant micelles, creating a tri-dimensional network between the thickener backbone and the micelles (associative effect).

The result of these two effects in the right conditions is the increase of viscosity of the liquid.

It is therefore a primary object of this invention to develop stabilised laundry detergent composition (or a composition to be used in conjunction with a laundry detergent) which incorporates a low cost, but effective, thickening system over a broad range of conditions. According to the first aspect of the present invention there is provided a liquid detergent composition having a thickening system which comprises triethanolamine.

Preferably the thickening system further comprises a LAS (linear alkylbenzene sulphonate) surfactant.

With the thickening system of the present invention it has been found that superior thickening of a liquid detergent composition can be achieved. Without wishing to be limited by theory it is postulated that the superior thickening is brought about by generation of a LAS-TEA salt, which gives rise to the formation of micelles, and high viscosity. Preferably the triethanolamine is present in an amount of up to 10 wt percent, more preferably from 0.1 to 5 wt percent, more preferably from 1 to 4 wt percent and most preferably from 1.4 to 3 wt percent.

Additionally during our trials we observed that, if the new liquid is manufactured using some non-ionics that suit the “non-labeling” criteria, despite they produce a chemically-physically stable laundry liquid the foam control of the detergent is very poor. This creates issues in both industrial production and during consumer usage.

An exceed of foaming during manufacturing and during filling into bottles will required extra work or a lower speed line with a consequence increase of manufacturing cost

Too much foam in the consumer use of the washing machine, could damage the washing machine, since the turbidimeter sensor could be damage or not working well increasing the number of rinsing. In the worst case scenario the foam could go out and create damage to the room where the washing machine has been installed.

Preferably the composition comprises from 0.001 percent to 99.99 percent, preferably 0.001 percent to 20 percent, preferably 4 percent to 18 percent, e.g. most preferably about 4.5 percent or 13 percent, by weight, of bleach. The bleach is preferably peroxide bleach, most preferably hydrogen peroxide. Peroxide sources other than H₂O₂ can be used.

Preferably the composition comprises a surfactant. Where present the composition comprises from 0.001 percent to 99.99 percent, preferably 0.05 percent to 40 percent, preferably 10 percent to 30 percent, e.g. about 25 percent, by weight of surfactant.

The surfactant is, for example, an anionic or nonionic surfactant or mixture thereof (most preferably a nonionic surfactant). The nonionic surfactant is preferably a surfactant having a formula RO (CH₂CH₂O) ₙH where-in R is a mixture of linear, even carbon-number hydrocarbon chains ranging from C₁2H2₅ to C₁₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide. Other examples of nonionic surfactants include primary alcohol ethoxylates (available under the Neodol trade name from Shell Co.), such as Cn alkanol condensed with 9 moles of ethylene oxide (Neodol 1-9), C₁2-13 alkanol condensed with 6.5 moles ethylene oxide (Neodol 23-6.5), Ci2-i3 alkanol with 9 moles of ethylene oxide (Neodol 23-9), C12-15 alkanol condensed with 7 or 3 moles ethylene oxide (Neodol 25-7 or Neodol 25-3), C₁₄-15 alkanol condensed with 13 moles ethylene oxide (Neodol 45-13), Cg-n linear ethoxylated alcohol, averaging 2.5 moles of eth-ylene oxide per mole of alcohol (Neodol 91-2.5), and the like.

Other examples of nonionic surfactants suitable for use in the present invention include ethylene oxide conden-sate products of secondary aliphatic alcohols containing 11 to 18 carbon atoms in a straight or branched chain configuration condensed with 5 to 30 moles of ethylene oxide. Examples of commercially available non-ionic detergents of the foregoing type are Cn-15 secondary alka-nol condensed with either 9 moles of ethylene oxide (Tergitol 15-S-9) or 12 moles of ethylene oxide (Tergitol 15-S-12) marketed by Union Carbide, a subsidiary of Dow Chemical. Octylphenoxy polyethoxyethanol type nonionic surfactants, for example, Triton X-100, as well as amine oxides can also be used as a nonionic surfactant in the present invention. Other examples of linear primary alcohol ethoxylates are available under the Tomadol trade name such as, for example, Tomadol 1-7, a Cn linear primary alcohol ethoxylate with 7 moles EO; Tomadol 25-7, a C₁2-C15 linear primary alcohol ethoxylate with 7 moles EO; Tomadol 45-7, a C₁₄-C15 linear primary alcohol ethoxylate with 7 moles EO; and Tomadol 91-6, a Cg-Cn linear alcohol ethoxylate with 6 moles EO.

Other examples of linear primary alcohol ethoxylates are available under the Lutensol trade name such as, for example, Lutensol A3N, a C13-15 linear primary alcohol eth-oxylate with 3 moles EO; Lutensol LA60, a C13-15 linear primary alcohol ethoxylate with 7 moles EO. Also Ge-napol such as, for example, Genapol LA3, a C13-15 linear primary alcohol ethoxylate with 3 moles EO; Genapol LA070, a C13-15 linear primary alcohol ethoxylate with 7 moles EO

Tomadol 45-7, a C14-C15 linear primary alcohol ethoxylate with 7 moles EO; and Tomadol 91-6, a Cg-Cn linear alco-hoi ethoxylate with 6 moles EO.

Other nonionic surfactants are amine oxides, alkyl amide oxide surfactants. Preferred anionic surfactants are frequently provided as alkali metal salts, ammonium salts, amine salts, amino-alcohol salts or magnesium salts. Contemplated as useful are one or more sulfate or sulfonate compounds including: alkyl benzene sulfates, alkyl sulfates, alkyl ether sulfates, alkylamidoether sulfates, alkylaryl pol-yether sulfates, monoglyceride sulfates, alkyl-sulfonates, alkylamide sulfonates, alkylarylsulfonates, olefinsulfonates, paraffin sulfonates, alkyl sulfosuccinates, alkyl ether sulfosuccinates, alkylamide sul-fosuccinates, alkyl sulfosuccinamate, alkyl sulfoace-tates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Other surfactants which may be used are alkyl naphthalene sulfonates and acyl/oleoyl sarcosinates and mixtures thereof.

The composition may various optional ingredients, including enzymes, builders, solvents, dye transfer inhibition agents, dye catchers, preservatives, anti oxidants, anti-static agents, fragrances, odour absorb-ing components, optical brighteners, acidifying agents, alkalizing agents, thickeners (e.g. hydroxyethylcellu-lose and/or xanthan gum).

The pH range of the fabric treatment composition is typ-ically from about 1 to about 8, e.g. from 3 to 5, more preferably from 3.6-4.3.

The composition is preferably used in a washing machine cycle and/or as a pre-soaker/soaker in a clothes cleaning operation, e.g. as a fabric treatment composition. The invention will be illustrated with reference to the following non-limiting Examples.

1. A liquid detergent composition comprising triethanolamine.

2. The liquid detergent composition of claim 1, which further comprises linear alkylbenzene sulphonate surfactant.

3. (canceled)

4. (canceled)

5. A liquid detergent composition which comprises a thickening system which includes both a triethanolamine and a linear alkylbenzene sulfonate surfactant in amounts wherein the triethanolamine interacts with the linear alkylbenzene sulfonate surfactant to form a linear alkylbenzene sulfonate-triethanolamine salt which imparts an increased viscosity in the liquid detergent composition.

6. The liquid detergent composition of claim 5, wherein the triethanolamine comprises 0.1 to 5 wt % of the liquid detergent composition.

7. The liquid detergent composition of claim 6, which further comprises 0.001-20% wt. of a bleach.

8. The liquid detergent composition of claim 6, which comprises 4-18% wt. of a bleach.

9. The liquid detergent composition of claim 8, which comprises 4.5-13% wt. of a bleach.

10. The liquid detergent composition of claim 2 which comprises 0.05-40% wt. of at least one additional surfactant.

11. The liquid detergent composition of claim 6 which comprises 0.01% wt. of at least one additional surfactant.

12. The liquid detergent composition of claim 11 which comprises 0.05-40% wt. of the at least one additional surfactant.

13. The liquid detergent composition of claim 12 which comprises 10-30% wt. of the at least one additional surfactant.

14. The liquid detergent composition of claim 1, which has a pH in the range of 1-8.

15. The liquid detergent composition of claim 6, which has a pH in the range of 1-8.

16. The liquid detergent composition of claim 15, which has a pH in the range of 3-5.

17. The liquid detergent composition of claim 16, which has a pH in the range of 3.6-4.3.

18. A method of treating clothes and/or fabrics, the method comprising the step of: contacting the clothes and/or fabrics with the liquid detergent composition of claim 5.

19. A method of treating clothes and/or fabrics, the method comprising the step of:
contacting the clothes and/or fabrics with the liquid detergent composition of claim 6.
